(19) United States
(12) Patent Application Publication
(10) Pub. No.: US 2017/0363422 A1
(43) Pub. Date: Dec. 21, 2017

(54) Lasergizmo

(71) Applicant: James Pokracki, Manhattan, KS (US)

(72) Inventor: James Pokracki, Manhattan, KS (US)

(21) Appl. No.: 15/187,781

(22) Filed: Jun. 21, 2016

(51) Int. Cl. G01C 15/10

(52) U.S. Cl. CPC G01C 15/105

(57) ABSTRACT

A laser holding device is disclosed including cylindrical or hexagonal tube threaded at both ends and can be constructed of metal or Polyvinyl chloride.

### FIELD OF INVENTION

Aspects of the present disclosure relate generally to pointers and relates more particularly to a pen-like laser holding device used for drilling purposes, as a plumb bob, to give direction of future pipe, setting hangers for various pipe sizes amongst others.

### BACKGROUND

A variety of laser pointers have been known but not many laser holding devices have appeared on the market. But not one of them has the advantages of the Lasergizmo. For instance, the Lasergizmo has a sleek compact portable design that makes it easy to carry around. It is not as delicate as rotating or self-leveling lasers and can withstand more of an impact.

### SUMMARY OF THE INVENTION

The Lasergizmo points a laser light from a battery powered laser module in the direction of a threaded fitting or smooth pipe. By attaching various bushings and or couplings the device will attach to any pipe type and size. The Lasergizmo can be constructed of metal or Polyvinyl chloride. The Lasergizmo relates to holding device for a laser module to precisely aim a laser—from multiple attachment options. More particularly, the present invention relates to a holding device which projects bright laser beam or lines to act as alignment guides for accurately guide the path of the intended direction of the pipe or item it is attached to. It can be used as a plumb bob with a laser light pointing at a plumb point on the floor to provide a vertical reference point.

### BRIEF DESCRIPTION OF THE DRAWINGS

FIG. 1. FIG. 1 shows a perspective view of the invention.

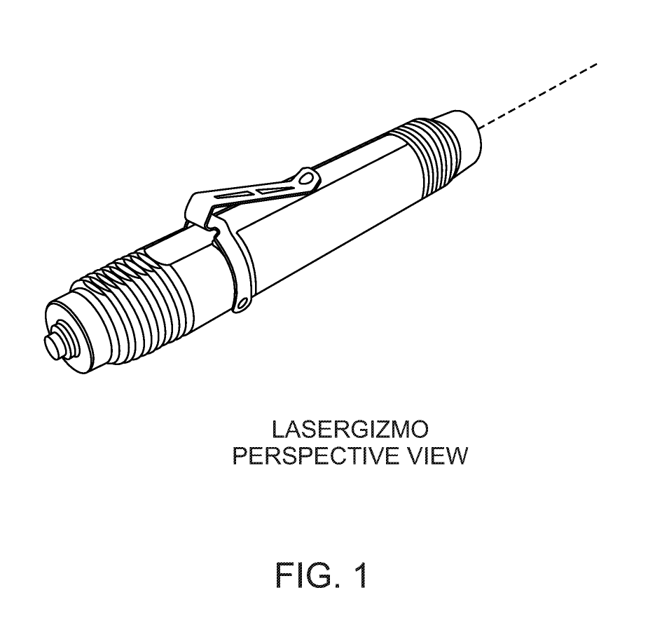

FIG. 2. FIG. 2 shows an exploded version of the invention.

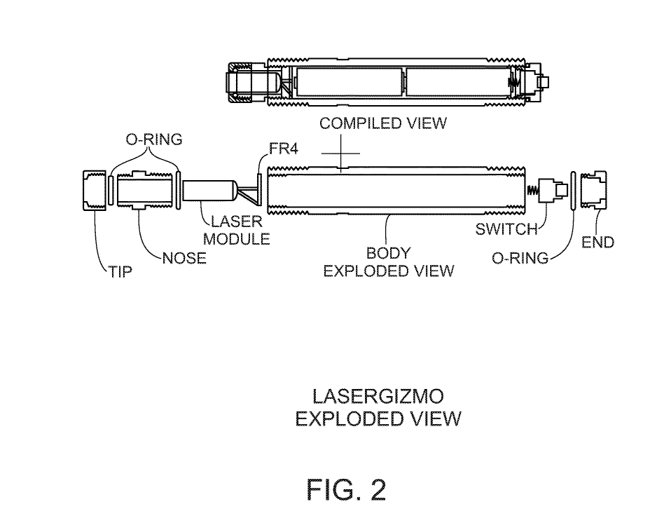

FIG. 3. FIG. 3 shows shows one application of the invention as a plump bob.

FIG. 4. FIG. 3 shows another application of the invention where the invention is used to give the direction of future pipe location for drilling holes.

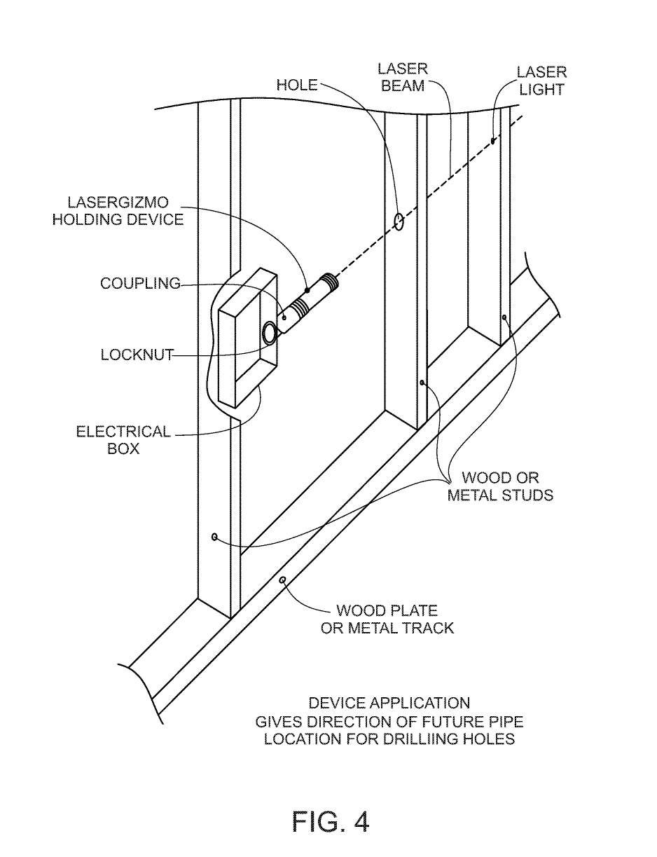

FIG. 5. FIG. 3 shows another application of the invention for setting hangers for various pipe sizes.

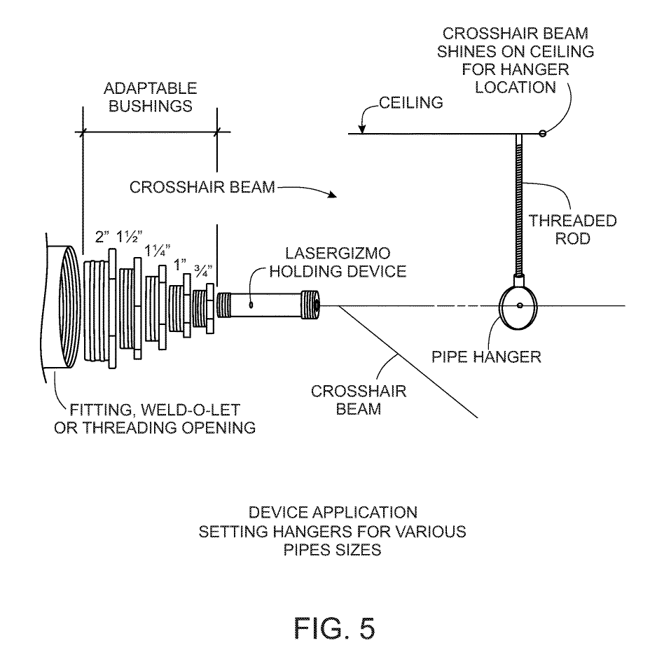

### DETAILED DESCRIPTION AND BEST MODE OF IMPLEMENTATION

The Lasergizmo is a cylindrical or hexagonal tube threaded at both ends and can be constructed of metal or Polyvinyl chloride. Inside the Lasergizmo is a battery compartment, a laser module, and an on/off switch. This device points a laser light from a battery powered laser module in the direction of a threaded fitting or smooth pipe. It has the following characteristics:
1. It inserts into fittings, couples onto and or compresses onto pipes.
2. Interchangeable to different pipe sizes: It attaches to many pipe sizes and material variations easily with the use of standard sized bushings, couplings and connectors.
3. Slip resistant outer shell to prevent accidental slippage.

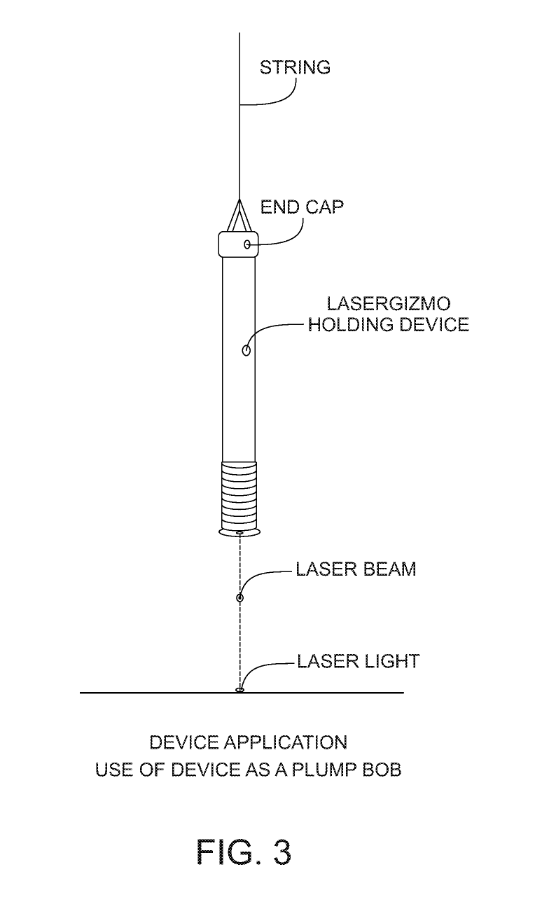

FIG. 3 shows one aspect of the invention where it allows the device to point a laser light in the direction of the intended pipes direction by threading into or wrapping around a pipe. The laser point or crosshair is projected on the intended target or impediment, thus give the location for drilling, coring, cutting or sawing to allow the pipe to continue its intended path unobstructed and in line with the pipe plane.

1. A pen-like holding device used for drilling purposes, giving direction of future pipe, setting hangers for various pipe sizes and have other uses.

2. The device as claimed in 1, threaded at both ends, consist of a battery compartment, a laser module, and an on/off switch.

3. The device as claimed in 2 may be constructed of metal or Polyvinyl chloride.

4. The device as claimed in 2 may be inserted into fittings and compressed onto pipes.

5. The device as claimed in 2 is capable of being attached to many pipe sizes and material variations easily with the use of standard sized bushings, couplings and connectors
